(19) United States
(12) Patent Application Publication
(10) Pub. No.: US 2023/0295472 A1
(43) Pub. Date: Sep. 21, 2023

(54) WATER SEALING ADHESIVE FILM FOR DECORATION

(71) Applicant: 3M INNOVATIVE PROPERTIES COMPANY, St. Paul, MN (US)

(72) Inventor: Hidetoshi Abe, Yamagata (JP)

(21) Appl. No.: 18/014,835

(22) PCT Filed: Jul. 2, 2021
(86) PCT No.: PCT/IB2021/055975

§ 371 Date: Jan. 6, 2023

(30) Foreign Application Priority Data
Jul. 10, 2020 (JP) 2020-119354

(51) Int. Cl. C09J 7/38; C09J 7/40; C08K 7/16

(52) U.S. Cl. CPC C09J 7/385; C09J 7/403; C08K 7/16; C09J 2301/208; C09J 2433/00; C09J 2301/412; C09J 2301/408

(57) ABSTRACT

To provide a water sealing adhesive film for decoration that can reduce or prevent the infiltration of water into an interface between an adhesive layer and an adherend even in an environment where the adhesive film can be contacted with water. A water sealing adhesive film for decoration according to an embodiment of the present disclosure includes: a substrate; and an adhesive layer having a structured surface and being disposed on the substrate, the adhesive layer containing a tacky binder having a crosslinked structure derived from a crosslinking agent, and a water absorbing resin.

### TECHNICAL FIELD

The present disclosure relates to an adhesive film for decoration.

### BACKGROUND ART

In recent years, various adhesive films have been developed and used in a wide range of fields, such as interior products or exterior products.

Patent Document 1 (JP H09-157606 A) describes an adhesive film that can be used outdoors, including: I) a support, and II) an adhesive film which is formed on the support and contains tacky elastic microspheres and a tacky polymer, wherein a) the adhesive layer has convex adhesive parts containing a cluster of at least two of the elastic microspheres and the tacky polymer, and b) a contact area rate between the adhesive layer and a flat glass plate surface is from 20% to 90% when the contact area rate is measured by adhering the adhesive film to the plate surface under the pressure of 1 kg/cm.

Patent Document 2 (JP 2018-178080 A) describes an adhesive film that can be used for a wall surface or the like of a building, the adhesive film including:
a rigid substrate having a thickness of 80 micrometers or greater and 500 micrometers or less, and
a first pressure sensitive adhesive layer disposed on or above one surface of the rigid substrate, the adhesive layer containing elastic resin microspheres having a volume average particle diameter of 110 micrometers or greater and a tacky binder,
wherein the first pressure sensitive adhesive layer has an uneven surface due to the presence of the microspheres.

### CITATION LIST

### Patent Literature

Patent Document 1: JP H09-157606 A
Patent Document 2: JP 2018-178080 A

### SUMMARY OF INVENTION

### Technical Problem

When an adhesive film is used in decorative applications, an uneven layer, as described in Patent Documents 1 and 2, may be formed on an adhesive layer of an adhesive film so as to enable formation of a channel (passage) communicating with the outside air at an interface between an adherend and the adhesive film, in order to prevent appearance failure associated with air accumulation that can occur at the interface.

When an adhesive film in which such a channel can be formed is used in an environment where the adhesive film can be contacted with water, there is a risk that water may infiltrate into an interface between an adherend and the adhesive film through the channel due to a capillary phenomenon or the like, with the result that adhesive forces may decrease, leading to defects such as peeling. In order to prevent such water infiltration, it is conceivable that the end parts of the film are edge-sealed or reinforced with any other film. However, such methods require much labor, which may lead to an increase in costs.

When the adherend is a porous body such as concrete, water soaked in the adherend can leach out into the interface between the adherend and the adhesive film, but, in such a case, it is difficult to prevent the infiltration of water.

The present disclosure provides a water sealing adhesive film for decoration that can reduce or prevent the infiltration of water into an interface between an adhesive layer and an adherend even in an environment where the adhesive film can be contacted with water.

### Solution to Problem

According to an embodiment of the present disclosure, provided is a water sealing adhesive film for decoration includes: a substrate; and an adhesive layer with a structured surface disposed on the substrate, the adhesive layer containing a tacky binder having a crosslinked structure derived from a crosslinking agent, and a water absorbing resin.

According to another embodiment of the present disclosure, provided is a structure in which the above-described water sealing adhesive film for decoration is disposed, via the adhesive layer, on an adherend.

### Advantageous Effects of Invention

According to the present disclosure, it is possible to provide a water sealing adhesive film for decoration that can reduce or prevent the infiltration of water into an interface between an adhesive layer and an adherend even in an environment where the adhesive film can be contacted with water.

The above description should not be construed as disclosing all embodiments of the present invention and all advantages relating to the present invention.

### BRIEF DESCRIPTION OF DRAWINGS

FIG. 1 is a cross-sectional view of a water sealing adhesive film for decoration according to an embodiment of the present disclosure.

FIG. 2 is a cross-sectional view of a water sealing adhesive film for decoration according to another embodiment of the present disclosure.

FIG. 3 is a cross-sectional view of a water sealing adhesive film for decoration according to another embodiment of the present disclosure.

FIG. 4 is a schematic view illustrating a state in which water infiltration is prevented in a water sealing adhesive film for decoration according to an embodiment of the present disclosure which is applied to an adherend.

FIG. 5(a) is a photograph of a sample of Comparative Example 1 after a water sealing test.

FIG. 5(b) is a photograph of a sample of Example 3 after the water sealing test.

FIG. 5(c) is a photograph of a sample of Example 4 after the water sealing test.

FIG. 5(d) is a photograph of a sample of Example 5 after the water sealing test.

### DESCRIPTION OF EMBODIMENTS

Hereinafter, representative embodiments of the present invention will be described in more detail with reference to the drawing as required for the purpose of illustration, but the present invention is not limited to these embodiments. Regarding the reference numbers in the drawings, constituents labeled with similar numbers across different drawings are similar or corresponding constituents.

In the present disclosure, the term “film” encompasses articles referred to as “sheets”.

In the present disclosure, the term “on”, for example used in “a decorative layer is disposed on the substrate” means that the decorative layer is disposed directly on the upper side of the substrate, or that the decorative layer is indirectly disposed on the upper side of the substrate via other layers.

In the present disclosure, the term “under”, for example used in “an adhesive layer is disposed under the substrate” means that the adhesive layer is disposed directly under the lower side of the substrate, or that the adhesive layer is indirectly disposed under the lower side of the substrate via other layers.

In the present disclosure, the phrase “structured surface” means an uneven surface that, when the adhesive film is applied to an adherend, can form a channel (passage) communicating with the outside air at an interface between them.

In the present disclosure, the phrase “water sealing property” means the ability to reduce or prevent the infiltration of water into the interface between the adhesive film and the adherend.

In the present disclosure, “substantially” means that a variation caused by a manufacturing error or the like is included, and is intended to allow a variation of approximately ±20%.

In the present disclosure, “transparent” refers to an average transmittance in the visible light region (wavelength from 400 nm to 700 nm) measured in accordance with JIS K 7375 of approximately 80% or greater, and the average transmittance may be desirably approximately 85% or greater or approximately 90% or greater. The upper limit of the average transmittance is not particularly limited, and can be, for example, less than approximately 100%, approximately 99% or less, or approximately 98% or less.

In the present disclosure, “translucent” refers to an average transmittance in the visible light region (wavelength from 400 nm to 700 nm) measured in accordance with JIS K 7375 of less than approximately 80%, and the average transmittance may be desirably approximately 75% or less, and is intended not to completely hide an underlying layer.

In the present disclosure, the term “(meth)acrylic” refers to acrylic or methacrylic, and the term “(meth)acrylate” refers to acrylate or methacrylate.

Hereinafter, a water sealing adhesive film for decoration according to the present disclosure will be described with reference to the drawings as necessary.

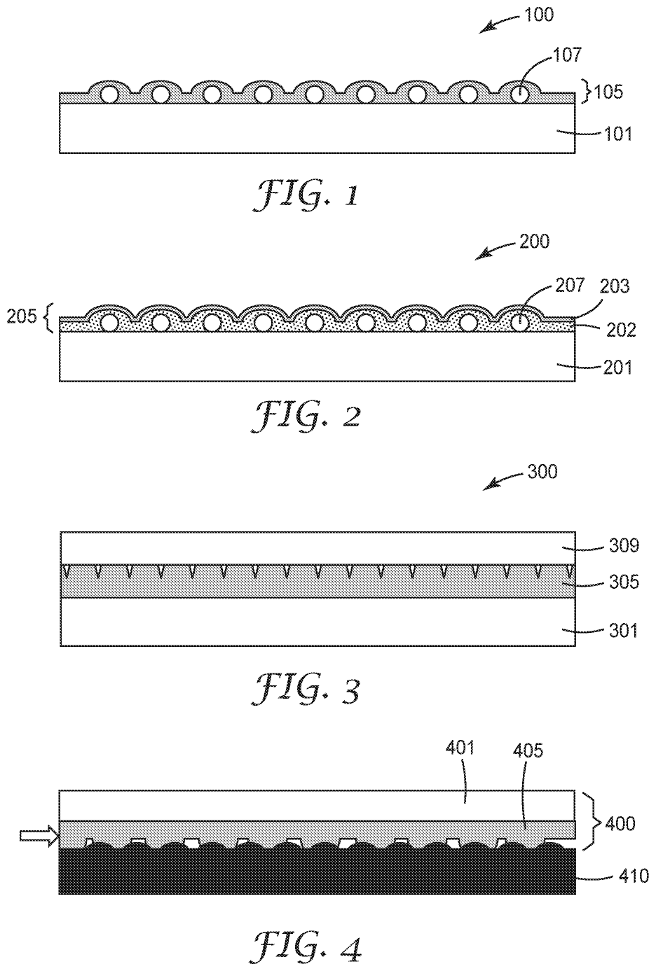

A water sealing adhesive film for decoration 100 in FIG. 1 is provided with a substrate 101 and an adhesive layer 105.

Hereinafter, for the purpose of illustrating representative embodiments of the present disclosure, details of each component will be described with some reference signs omitted.

The water sealing adhesive film for decoration of the present disclosure (sometimes referred to simply as “adhesive film”) includes a substrate. Such a substrate can be used, for example, as a support for an adhesive layer or any other layer (for example, a decorative layer). The substrate may have a receptor layer on its surface, or the substrate itself may have receptor performance. By using a substrate having a receptor layer or receptor performance, a decorative layer such as a graphic image can be directly formed on the substrate by inkjet printing or the like.

For example, the adhesive layer may be applied to one surface of the substrate and any layer may be applied to the other surface, or any layer such as a decorative layer may be applied to one surface of the substrate and the adhesive layer may be applied onto the layer. When the adhesive film having the latter structure is applied to an adherend via the adhesive layer, the substrate is configured to be disposed on the outermost layer, so that the substrate can exhibit the same function as that of the protective layer. The surface of the substrate may be subjected to surface treatment such as embossing treatment for decoration or the like, corona treatment, or plasma treatment.

Examples of the material for the substrate include polyvinyl chloride resins, polyurethane resins, polyolefin resins (for example, polyethylene and polypropylene), polyester resins (for example, polyethylene terephthalate and polyethylene naphthalate), polycarbonate resins, polyimide resins, polyamide resins, (meth)acrylic resins, and fluorine resins (for example, polytetrafluoroethylene and polyvinylidene fluoride). These components can be used alone, or in combination of two or more.

The thickness of the substrate is not particularly limited, and can be appropriately selected in accordance with the use application of the adhesive film and the like. The thickness can be, for example, approximately 50 micrometers or greater, approximately 80 micrometers or greater, approximately 100 micrometers or greater, or approximately 150 micrometers or greater. The upper limit of the thickness of the substrate is not particularly limited. From the viewpoint of rigidity, manufacturing costs, and the like, the thickness can be, for example, approximately 500 micrometers or less, approximately 400 micrometers or less, approximately 300 micrometers or less, or approximately 200 micrometers or less. Typically, the cross section in the thickness direction of the laminated structure is measured using a scanning electron microscope, and the thickness of each layer constituting the adhesive film can be defined as the average value of the thicknesses at at least any five points of a target layer in the laminated structure, for example, the substrate.

In some embodiments, a substrate exhibiting rigidity (sometimes referred to as a “rigid substrate”) can be used. Such a substrate can prevent deformation of the adhesive film associated with swelling of the water absorbing resin in the adhesive layer, or prevent deformation of the adhesive film by resisting the stress caused by deformation of the microspheres contained in the adhesive layer when the adhesive film is applied, thereby contributing to keeping the appearance of the adhesive film smooth. When the adherend has an uneven surface, the rigid substrate can suppress excessive conforming of the adhesive film to the uneven surface during adhesion and prevent the protrusions of the uneven surface from penetrating the adhesive film. When the adhesive film is applied to a vertical surface, the rigid substrate can prevent releasing caused by the weight of the adhesive film by suppressing deformation of the adhesive film.

In some embodiments, the yield modulus of the rigid substrate can be approximately 10 MPa or greater, approximately 15 MPa or greater, or approximately 20 MPa or greater, and can be approximately 300 MPa or less, approximately 250 MPa or less, or approximately 200 MPa or less. By setting the yield modulus of the rigid substrate to be within the range described above, the smoothness of appearance of the adhesive film can be maintained during adhesion by the combination with the thickness of the substrate. The yield modulus is defined as a modulus of elasticity at the yield point when a test piece is produced by cutting a rigid substrate into a rectangular shape with a width of 15 mm and a length of 100 mm, and the elongation properties of the test piece is measured using a tensile tester in accordance with JIS K 7127 under the condition at 20° C., the distance between grips of 50 mm, and the tensile speed of 300 mm/min.

In some embodiments, the product of the yield modulus and the thickness of the rigid substrate is approximately 0.9×10⁴ N/m or greater, approximately 1.0×10⁴ N/m or greater, or approximately 1.5×10⁴ N/m or greater, and can be approximately 5×10⁴ N/m or less, approximately 4×10⁴ N/m or less, or approximately 3×10⁴ N/m or less. The product of the yield modulus and the thickness is proportional to the bending stiffness of the rigid substrate. By setting the product of the yield modulus and the thickness of the rigid substrate to be within the range described above, the rigid substrate can have sufficient bending stiffness to maintain the smoothness of appearance of the adhesive film during adhesion.

In some embodiments, the tensile strength at 2% strain of the rigid substrate is approximately 40 N/25 mm or greater, approximately 45 N/25 mm or greater, or approximately 50 N/25 mm or greater. By setting the tensile strength at 2% strain of the rigid substrate to be within the range described above, the smoothness of appearance of the adhesive film can be maintained during adhesion, and the adhesive film can be removed without causing rupture or breakage of the adhesive film and without leaving adhesive residue caused thereby. The tensile strength at 2% strain is defined as a tensile strength at 2% strain when a test piece is produced by cutting a rigid substrate into a rectangular shape with a width of 25 mm and a length of 100 mm and measured using a tensile tester under the condition at 20° C., the distance between grips of 50 mm, and the tensile speed of 300 mm/min.

The substrate may be a stretched film or an unstretched film. The rigidity and tensile strength of the substrate can be advantageously enhanced by using a stretched film, especially a biaxially stretched film, as the substrate.

The substrate is typically preferably transparent or translucent (e.g., milky white), but to provide an intended appearance, the substrate may be entirely or partially transparent, translucent, or opaque in the visible range. The substrate may be colorless or may be colored entirely or partially.

The substrate may contain other optional components, such as fillers, colorants such as pigments or dyes, UV absorbents, antioxidants, light stabilizers, flame retardants, antibacterial agents, and deodorants.

The water sealing adhesive film for decoration of the present disclosure includes an adhesive layer having a structured surface.

The topography of the structured surface (shape or characteristics of the surface) formed on the surface of the adhesive layer disposed on the substrate is not particularly limited as long as a network of channels or similar structures through which air can pass from the lateral direction at the interface between the adhesive layer and the adherend when the structured surface side of the adhesive layer is applied to the adherend.

The structured surface of the adhesive layer can be formed by, for example, (1) applying an adhesive composition onto a release liner having an uneven surface such as an embossed pattern corresponding to the structured surface; (2) pressing the adhesive layer applied to a release liner having an uneven surface such as an embossed pattern corresponding to the structured surface, or (3) applying an adhesive composition containing microspheres to the substrate.

The method of application to the release liner or substrate is not particularly limited, and the application can be performed by, for example, a knife coater, a gravure coater, a roll coater, a die coater, or a bar coater. After the adhesive composition is applied, a solvent can be dried as needed. The drying can be performed, for example, at a temperature of 60° C. to 120° C. for 10 seconds to 10 minutes.

The adhesive layer having the structured surface typically has a maximum thickness corresponding to the distance from the topmost part of a convex part to the surface of the other layer adjacent to the adhesive layer (e.g., substrate surface) in one convex region (e.g., a convex region around microspheres shown by reference numeral 107 in FIG. 1), and a minimum thickness corresponding to the distance from the bottommost part of a concave part formed between the convex region and the other convex region adjacent to the convex region to the surface of the other layer adjacent to the adhesive layer (e.g., substrate surface), as shown in FIGS. 1 to 3. The difference between the maximum thickness and the minimum thickness of the adhesive layer is an indicator of topography of the structured surface of the adhesive layer and, for example, can relate to the adhesiveness to a rough surface part.

In some embodiments, the difference between the maximum thickness and the minimum thickness of the adhesive layer can be approximately 50 micrometers or greater, approximately 70 micrometers or greater, or approximately 90 micrometers or greater, and can be approximately 400 micrometers or less, approximately 350 micrometers or less, or approximately 300 micrometers or less. By setting the difference between the maximum thickness and the minimum thickness of the adhesive layer to be within the range described above, the adhesive film can be well adhered to, for example, a rough surface part having protrusions with a height from 1 to 2 mm. The cross section in the thickness direction of the adhesive film is measured using a scanning electron microscope, and each of the maximum thickness and the minimum thickness of the adhesive layer can be defined as the average value of the thicknesses of the convex regions at at least any five points in the adhesive layer

The 60 degree gloss of the structured surface of the adhesive layer is another indicator showing topography of the structured surface of the adhesive layer, and such an indicator relates to, for example, adhesiveness to a rough surface. In some embodiments, the 60 degree gloss of the adhesive layer can be approximately 3 or greater, approximately 4 or greater, or approximately 5 or greater, and can be approximately 60 or less, approximately 55 or less, or approximately 50 or less. By setting the 60 degree gloss of the adhesive layer to be within the range described above, the adhesive sheet can be adhered to, for example, a rough surface part having protrusions with a height of 1 to 2 mm, by strong adhesive force. The 60 degree gloss is defined as a value measured in accordance with JIS Z8741.

The thickness of the adhesive layer having the structured surface corresponds to the maximum thickness described above. The thickness of the adhesive layer is not particularly limited, and can be, for example, approximately 30 micrometers or greater, approximately 40 micrometers or greater, approximately 50 micrometers or greater, approximately 60 micrometers or greater, approximately 70 micrometers or greater, or approximately 80 micrometers or greater, and can be approximately 220 micrometers or less, approximately 200 micrometers or less, or approximately 180μ or less.

The adhesive layer of the present disclosure contains a tacky binder having a crosslinked structure derived from a crosslinking agent, and a water absorbing resin. In the field of decorative films, shrinkage of the film after being adhered to an adherend may lead to a decrease in decorative performance. Because the tacky binder constituting the adhesive layer of the present disclosure has a crosslinked structure derived from a crosslinking agent, such shrinkage of the film can be reduced or suppressed. On the other hand, an adhesive layer containing a tacky binder having a crosslinked structure has excellent shape retention as compared with an adhesive layer containing a tacky binder that does not have a crosslinked structure, and therefore, even if the adhesive film is adhered to the adherend by application of pressure using a roller, a spatula or the like, the channels at the interface tend to be maintained. Such channels, for example, can allow gas that can be generated, such as water vapor, to escape from the adherend, while possibly causing peeling associated with water infiltration. Because the adhesive layer of the present disclosure contains a water absorbing resin, for example, when water is contacted with an end part of an adhesive film applied to an adherend, or when water leached out from a porous adherend is contacted with the adhesive layer, the water absorbing resin that has absorbed water will swell, so that the infiltration of water from the channels or the like can be reduced or prevented.

The tacky binder is not particularly limited as long as it has a crosslinked structure derived from a crosslinking agent. As the tacky binder, publicly known resins, such as (meth)acrylic resins, polyurethanes, polyolefins, polyesters, rubber-based resins, silicone resins, and vinyl acetate resins can be used. These components can be used alone, or in combination of two or more. Among these, a (meth)acrylic resin is preferred from the viewpoint of adhesiveness, water sealing property, dispersibility of the water absorbing resin, and the like.

The crosslinked structure of the tacky binder can be imparted, for example, by heating or irradiation with ionizing radiation (for example, X-ray, electron beam, ultraviolet light, visible light, infrared light) after applying an adhesive composition containing a tacky binder, a crosslinking agent, and a water absorbing resin to a substrate.

The crosslinking agent is not particularly limited, and a known crosslinking agent such as a thermal crosslinking agent or an ultraviolet crosslinking agent can be used. By crosslinking the tacky binder using a crosslinking agent, the aggregation force of the adhesive layer can be enhanced and the reworkability and/or dimensional stability of the adhesive film can be improved. The crosslinked structure of the tacky binder can also contribute to the swelling of the water absorbing resin contained in the adhesive layer, that is, adhesiveness and water infiltration resistance of the adhesive layer. Water infiltration is prevented more easily as the water absorbing resin absorbs water and becomes larger, but the water absorbing resin generally does not exhibit adhesion performance, so there is a risk that the increase in volume of the water absorbing resin may reduce the adhesiveness. In other words, adjusting the crosslinked structure of the tacky binder can contribute to adjustment of the swelling performance of the water absorbing resin, that is, adjustment of the adhesiveness and water sealing property of the adhesive film.

From the viewpoint of adhesiveness, dimensional stability, swelling of the water absorbing resin, and the like, it is preferable to use a thermal crosslinking agent selected from the group consisting of an epoxy crosslinking agent and a bisamide crosslinking agent as the thermal crosslinking agent. Examples of the epoxy crosslinking agent include N,N,N′,N′-tetraglycidyl-1,3-benzenedi(methanamine) (available from Mitsubishi Gas Chemical Company Inc.: TETRAD-X); E-Ax and E-5XM available from Soken Chemical & Engineering Co., Ltd.; N,N′-(cyclohexane-1,3-diylbismethylene)bis(diglycidylamine) (available from Mitsubishi Gas Chemical Company Inc.: TETRAD-C); and E-5 C available from Soken Chemical & Engineering Co., Ltd. Examples of the bisamide crosslinking agent include, 1,1′-(1,3-phenylenedicarbonyl)-bis(2-methylaziridine) (1,1′-isophthaloyl-bis(2-methylaziridine)), 1,4-bis(ethyleneiminocarbonylamino)benzene, 4,4′-bis(ethyleneiminocarbonylamino)diphenylmethane, and 1,8-bis(ethyleniminocarbonylamino)octane.

The amount of the thermal crosslinking agent blended can be approximately 0.01 parts by mass or greater, approximately 0.02 parts by mass or greater, or approximately 0.05 parts by mass or greater, and can be approximately 0.5 parts by mass or less, approximately 0.4 parts by mass or less, or approximately 0.3 parts by mass or less, based on 100 parts by mass of the tacky binder, from the viewpoint of reworkability and dimensional stability of the adhesive layer, swelling of the water absorbing resin, and the like.

Examples of the ultraviolet crosslinking agent include compounds having a hydrogen radical abstraction structure, such as a benzophenone structure, a benzyl structure, an o-benzoyl benzoic ester structure, a thioxantone structure, a 3-ketocoumarin structure, a 2-ethylanthoraquinone structure, and a camphorquinone structure, from the viewpoint of adhesiveness, dimensional stability, swelling of the water absorbing resin, and the like. It is advantageous to use a compound having a benzophenone structure in terms of transparency and reactivity.

Examples of the ultraviolet crosslinking agent may be a (meth)acrylic polymer having a hydrogen radical abstraction structure selected from the group consisting of a benzophenone structure, a benzyl structure, an o-benzoyl benzoic ester structure, a thioxantone structure, a 3-ketocoumarin structure, a 2-ethylanthoraquinone structure, and a camphorquinone structure. By using a (meth)acrylic polymer having a hydrogen radical abstraction structure, the crosslinking reactivity can be enhanced while adjusting the viscosity of the adhesive composition. In an embodiment, the ultraviolet crosslinking agent is a benzophenone-modified (meth)acrylic polymer.

The amount of the ultraviolet light crosslinking agent blended can be approximately 0.1 parts by mass or greater, approximately 0.5 parts by mass or greater, or approximately 1 part by mass or greater, and can be approximately 20 parts by mass or less, approximately 10 parts by mass or less, or approximately 5 parts by mass or less, based on 100 parts by mass of the tacky binder, from the viewpoint of reworkability and dimensional stability of the adhesive layer, swelling of the water absorbing resin, and the like.

The water absorbing resin typically takes the form of particles and can be present in a dispersed state in the tacky binder.

The water absorbing resin is not particularly limited, and known water absorbing resins can be used. Examples of the resin material for the water absorbing resin can include sodium polyacrylate, acrylic acid-vinyl alcohol copolymer, crosslinked sodium polyacrylate, starch-acrylic acid graft copolymers, isobutylene-maleic anhydride copolymers and saponified products thereof, and polyaspartic acid. Among these, sodium polyacrylate is most preferable because the water absorption force is high, i.e., from 100 times to 1000 times the weight. The water absorbing resin blended in the adhesive layer may be composed of a single resin material or may be composed of two or more resin materials.

The water absorbing resin typically takes the form of particles, and the average particle diameter thereof is approximately 10 micrometers or greater, approximately 30 micrometers or greater, or approximately 50 micrometers or greater, and approximately 500 micrometers or less, approximately 300 micrometers or less, or approximately 100 micrometers or less, from the viewpoint of dispersibility thereof in the tacky binder, water sealing property, and the like. The particle diameter (D₅₀ value) of the water absorbing resin particles can be measured by a sieving method. The D₅₀ value is a value when 50 volume % of the particles are retained by a sieve having the corresponding mesh size.

From the viewpoint of adhesiveness, water sealing property, and the like, the amount of the water absorbing resin blended is preferably approximately 1 part by mass or greater, approximately 2 parts by mass or greater, or approximately 3 parts by mass or greater, but approximately 30 parts by mass or less, approximately 20 parts by mass or less, approximately 10 parts by mass or less, approximately less than 10 parts by mass, approximately 9 parts by mass or less, or approximately 8 parts by mass or less, based on 100 parts by mass of the tacky binder (solid content: 100%), as converted in terms of solid matter. The water absorbing resin does not exhibit adhesiveness, but, on the other hand, swells upon absorption of water and develops water sealing property. When the amount of the water absorbing resin blended is within the range described above, it is possible to obtain an adhesive layer more excellent in balance between adhesiveness and water sealing property.

In some embodiments, the structured surface of the adhesive layer of the present disclosure can be prepared using an adhesive composition containing microspheres 107, as illustrated in FIG. 1.

The microspheres are not particularly limited, and are preferably microspheres having a volume average particle diameter of approximately 110 micrometers or greater from the viewpoint of formation of the structured surface, and more preferably elastic resin microspheres having a volume average particle diameter of approximately 110 micrometers or greater from the viewpoint of adhesiveness to the adherend.

In the present disclosure, “elastic resin microsphere” is defined as a spherical raw material that is formed from a resin. Typically, the microspheres exhibit rubber elasticity as a whole. During adhesion of the adhesive film to the adherend, the elastic resin microspheres can deform, for example, so as to collapse in the thickness direction of the adhesive film. Therefore, the contact area of the adhesive layer with the adherend surface increases, and thereby the adhesive film can be well adhered to the adherend surface. Since the volume average particle diameter of the elastic microspheres is relatively large, high adhesive force can be achieved by utilizing the elasticity of the microspheres even when the contact area with the adherend is relatively small, similar to the case where a thick pressure sensitive adhesive layer exhibits excellent adhesive force. The uneven surface formed due to the microspheres can make the contact area with a rough surface part of the adherend larger, for example, due to its relatively large difference of height, thereby enhancing the adhesive force.

In an embodiment, the elastic resin microspheres are tacky. By using tacky elastic resin microspheres, adhesive force can be further enhanced.

The volume average particle diameter of the microspheres is approximately 110 micrometers or greater. In some embodiments, the volume average diameter of the microspheres is approximately 125 micrometers or greater or approximately 130 micrometers or greater, and is approximately 500 micrometers or less or approximately 300 micrometers or less. The adhesive layer containing the microspheres having the volume average particle diameter within the range described above can suitably conform to the adherend surface and can exhibit high adhesive force. The volume average particle diameter of the microspheres can be measured by using a laser diffraction particle diameter analyzer, such as Beckman Coulter LS230.

The compressive elastic modulus of the elastic resin microspheres at 20° C. is preferably approximately 1 kPa or greater but approximately 100 kPa or less. By setting the compressive elastic modulus of the elastic resin microspheres to be within the range described above, the microspheres or the clusters of microspheres which are masses in which two or more microspheres are aggregated can be deformed in a manner which is advantageous for adhesion to a rough surface. The compressive elastic modulus of the microspheres is a measured value at 20° C. determined by producing a sample obtained by forming microspheres having a predetermined shape, such as cylindrical shape, and performing measurement using a measurement instrument for viscoelasticity, such as RSA II viscoelasticity spectrometer manufactured by Rheometrics, under the following conditions: frequency: 1 rad/sec; compression strain mode; measurement temperature range: −80° C. to 150° C.; rate of temperature increase: 5.0° C./min.

The material for the microspheres is not particularly limited, and can be, for example, a metal material, an inorganic material, or a resin material, but is preferably a resin material from the viewpoint of developing the elastic action of the microspheres. Examples of such a resin material can include a (meth)acrylic resin, silicone resin, polyurethane, vinyl acetate-based resin, fluororesin, polyamide, polyvinyl chloride, polystyrene, phenolic resin, epoxy resin, styrene-butadiene-styrene block copolymer, styrene-ethylene-butylene-styrene block copolymer, styrene-isoprene-styrene block copolymer, nitrile rubber, chloroprene rubber, or natural rubber. A (meth)acrylic resin has high weather resistance and is advantageously used since controlling of the tackiness is easy. The microspheres blended in the adhesive layer may be composed of a single material or may be composed of two or more materials.

The microspheres may contain a crosslinked resin or an uncrosslinked resin. In an embodiment, the microspheres contain a crosslinked resin. Since the microspheres containing a crosslinked resin exhibit excellent shape retaining property and durability, repeated adhesion and detaching of the adhesive film are made possible.

The microspheres may contain solid particles, hollow particles having one or a plurality of gaps therein, or a mixture of these. In an embodiment, the microspheres are solid particles.

The microspheres composed of a resin material can be produced by publicly known polymerization methods, such as suspension polymerization, emulsion polymerization, and seed polymerization. For example, microspheres containing a (meth)acrylic resin can be produced by suspension polymerization by the following procedure.

Deionized water, a monomer mixture, a radical polymerization initiator, and optional additives are placed in a reaction equipment with a mechanical stirrer, inside of the reaction equipment is purged with an inert gas such as a nitrogen gas, and the mixture is heated to a predetermined temperature while being stirred to perform a polymerization reaction of a (meth)acrylic monomer. The stirring rate is typically from 10 to 700 rpm, the reaction temperature is typically from 30 to 120° C., and the reaction time is typically from several hours to several tens of hours.

The monomer mixture typically contains alkyl (meth)acrylate (e.g. ethyl (meth)acrylate, n-butyl (meth)acrylate, n-hexyl (meth)acrylate, 2-ethylhexyl (meth)acrylate, isooctyl (meth)acrylate, and isononyl (meth)acrylate) and carboxylic acid having an ethylenically unsaturated bond (e.g. (meth)acrylic acid, itaconic acid, and maleic acid). One type each of alkyl (meth)acrylate and carboxylic acid having an ethylenically unsaturated bond may be used, or a combination of two or more types of alkyl acrylate(s) and/or carboxylic acid(s) having an ethylenically unsaturated bond may be used. The carboxylic acid having an ethylenically unsaturated bond is typically used in an amount of approximately 1 part by mass or greater but approximately 10 parts by mass or less based on 100 parts by mass of alkyl (meth)acrylate. As a crosslinking agent, a polyfunctional monomer, such as 1,4-butanediol diacrylate and divinylbenzene, may be added to the mixture to crosslink the (meth)acrylic resin. The amount of the crosslinking agent used is typically approximately 0.01 parts by mass or greater or approximately 0.02 parts by mass or greater but approximately 0.5 parts by mass or less or approximately 0.1 parts by mass or less, based on 100 parts by mass of the monomer mixture. The microspheres obtained by polymerization may be separated by filtration or may be used in the state of an aqueous dispersion liquid containing microspheres after the termination of the reaction.

The glass transition temperature (Tg) of the resin contained in the microspheres is typically lower than room temperature and, for example, is approximately −90° C. or higher, approximately −70° C. or higher, or approximately −50° C. or higher, but approximately 0° C. or lower, approximately −10° C. or lower, or approximately −20° C. or lower. The glass transition temperature can be adjusted by the type and the blending ratio of monomers contained in the monomer mixture.

In an embodiment, the microspheres are contained in the adhesive layer in an amount of approximately 5 parts by mass or greater, approximately 10 parts by mass or greater, or approximately 15 parts by mass or greater, but approximately 200 parts by mass or less, approximately 180 parts by mass or less, or approximately 160 parts by mass or less, based on 100 parts by mass of the tacky binder. By setting the content of the microspheres to be within the range described above, an uneven structured surface exhibiting excellent adhesiveness even to a rough surface can be formed on the adhesive layer.

In an embodiment, the mass ratio of the tacky binder to the microspheres in the adhesive layer is 40:60 or greater but 90:10 or less. By setting the mass ratio of the tacky binder to the microspheres to be within the range described above, an uneven structured surface exhibiting excellent adhesiveness even to a rough surface can be formed on the adhesive layer.

The structured surface of the adhesive layer containing the microspheres may be formed by one microsphere 107, as illustrated in FIG. 1, but may be formed by a mass in which two or more microspheres are aggregated (sometimes referred to as “cluster of microspheres”). The cluster of microspheres is an aggregate of microspheres that form convex parts having irregular shapes and irregularly arranged on the adhesive layer. The cluster may contain a plurality of microspheres that are arranged in a planar direction of the adhesive film, may contain a plurality of microspheres that are stacked in the thickness direction of the adhesive film, or may contain a combination of these. The island structure formed with the cluster may contain a tacky binder. Around the island structure, there is a sea portion of the adhesive layer that does not contain a relatively flat cluster.

In the case where the microspheres are elastic resin microspheres, the microspheres in the clusters deform by pressure while the adhesive film is adhered to an adherend, the tacky convex parts deform into appropriate shapes to adhere to the adherend surface. The degree of deformation can be controlled by thickness and coating weight of the adhesive layer, compressive elastic modulus of the microspheres, blending ratio of the microspheres and the tacky binder, and the like.

In an embodiment, a cluster contains 2 or more, approximately 5 or more, or approximately 10 or more, but approximately 200 or less, approximately 150 or less, or approximately 100 or less microspheres. By setting the number of microspheres contained in the cluster to be within the range described above, unevenness of tackiness in the plane can be suppressed while conformity to the adherend surface is enhanced. Among all the clusters, preferably, 80% or greater of the clusters contain the number of microspheres described above. The formation, shape, and size of the clusters of the microspheres in the adhesive layer can be observed typically at a magnification of 10 times to 100 times using a reflected light of an optical microscope.

By adjusting the viscosity of the adhesive composition and/or the wettability of the surface of the substrate or the like to which the adhesive composition is to be applied, formation of clusters of the microspheres is promoted, and the shape, arrangement, and size of the clusters can be controlled. In some embodiments, the microspheres, which are dispersed in the composition containing the solvent and the tacky binder and, are transferred during the drying of the solvent since the microspheres are pulled by the tacky binder component dissolved in the solvent, and aggregate to form a cluster.

From the viewpoint of promoting the cluster formation, it is advantageous to set the viscosity of the adhesive composition to approximately 100 mPa·s or greater or approximately 150 mPa·s or greater, but approximately 6000 mPa·s or less or approximately 5000 mPa·s or less.

The wettability of the surface of the substrate or the like to which the adhesive composition is to be applied can be controlled in a manner that clusters are formed while the coating unevenness of the composition is suppressed by surface treatment such as corona discharge treatment, plasma treatment, primer treatment, or acid- or alkali-treatment, or by the type or amount of the additive(s) contained in the substrate.

The surface of the adhesive layer having a structured surface prepared using microspheres may be protected by a release liner. The material and thickness of the release liner can be similar to those of a release liner having an embossed pattern which will be described below.

In some embodiments, the structured surface of the adhesive layer of the present disclosure can be prepared using a release liner 309 having an uneven surface such as an embossed pattern corresponding to the structured surface, as shown in FIG. 3.

For example, the adhesive composition can be applied to the uneven surface of the release liner and optionally dried and/or crosslinked to transfer the uneven pattern to the adhesive layer. By applying the adhesive layer of the release liner provided with the obtained adhesive layer to the substrate, an adhesive film 300 can be obtained in which the release liner 309 having an uneven surface corresponding to the structured surface is disposed on an adhesive layer 305 via the uneven surface, as shown in FIG. 3.

Alternatively, an adhesive composition is applied onto a smooth first release liner and optionally dried and/or crosslinked to form an adhesive layer, and the adhesive layer is then applied to a second release liner having an uneven surface such as an embossed pattern corresponding to the structured surface and optionally dried and/or crosslinked, and further pressed, so that the uneven pattern can be transferred to the adhesive layer. After removal of the first release liner, the adhesive layer is applied to the substrate to obtain the adhesive film 300 in which the release liner 309 having an uneven surface corresponding to the structured surface is disposed on the adhesive layer 305 via the uneven surface, as illustrated in FIG. 3.

The release liner is not particularly limited, and examples thereof include those prepared from paper (e.g., kraft paper) or a polymer raw material (e.g., polyolefin, such as polyethylene or polypropylene; ethylene vinyl acetate; polyurethane; or polyester, such as polyethylene terephthalate). The release liner may be applied as necessary with a layer of a release agent, such as a silicone-containing raw material or a fluorocarbon-containing raw material.

The thickness of the release liner, for example, can be approximately 5 micrometers or greater, approximately 15 micrometers or greater, or approximately 25 micrometers or greater, and can be approximately 300 micrometers or less, approximately 200 micrometers or less, or approximately 150 micrometers or less. The thickness of the release liner, i.e., the distance from the topmost part to the bottommost part, can be defined as an average value calculated from at least five measurements of thickness at any portion of the release liner after removal from the adhesive layer, the measurements being made using High-Accuracy Digimatic Micrometer (MDH-25 MB, available from Mitutoyo Corporation).

The adhesive composition for forming the adhesive layer can contain other components in addition to the tacky binder, the crosslinking agent, and the water absorbing resin. Examples of such other components include fillers other than the microspheres described above, pigments, dyes, antioxidants, thermal stabilizers, light stabilizers, ultraviolet absorbents, flame retardants, antibacterial agents, deodorants, tackifiers, and other resins. These optional components can be used alone, or in combination of two or more.

The adhesive composition may contain a solvent or may be free of a solvent. The solvent is not particularly limited, but is preferably an organic solvent, from the viewpoint of swelling resistance of the water absorbing resin contained in the adhesive composition, and the like. Examples of such an organic solvent include methanol, ethanol, hexane, toluene, acetone, methyl ethyl ketone, methyl isobutyl ketone, ethyl acetate, butyl acetate, and mixed solvents thereof. In the case of the water absorbing resin-free adhesive composition used in the preparation of the first adhesive layer which will be described below, water, an organic solvent, or an aqueous solvent which is a mixture thereof can be used as the solvent. Examples of the aqueous solvent include mixtures of water and an alkylene glycol monoalkyl ether ester, such as 3-methyl-3-methoxybutylacetate.

In some embodiments, the adhesive layer may have a laminated structure including a first adhesive layer located on the substrate side and a second adhesive layer located on the outermost surface. For example, the first adhesive layer can contain a tacky binder having a crosslinked structure derived from a crosslinking agent, and optionally microspheres and/or a water absorbing resin, and the second adhesive layer can contain a tacky binder having a crosslinked structure derived from a crosslinking agent, and a water absorbing resin.

An adhesive layer having such a laminated structure is advantageous when an adhesive layer 205 containing microspheres 207, as illustrated in FIG. 2, is employed. When an adhesive layer containing microspheres is formed using an adhesive composition, the adhesive composition near the top parts of the microspheres tends to flow towards the concave parts (valleys). As a result, the layer containing the tacky binder formed near the top parts of the microspheres tends to be thin like a skin as compared with other locations, and thus the performance such as adhesiveness or the like may decrease. On the other hand, in the case of the laminated structure, the second adhesive layer can be laminated near the top parts that are thinned like a skin to be increased in thickness. Thus, the wettability, adhesiveness and the like to the adherend can be improved.

The second adhesive layer containing the water absorbing resin may be applied to the entire surface of the first adhesive layer or may be partially applied thereto. For example, the second adhesive layer may be applied partially to the first adhesive layer located around an end part of the adhesive film or may be applied to the concave part of the uneven structured surface as shown in FIG. 1, that is, a portion that can form a channel through which air can pass from the lateral direction at an interface between the adhesive layer and the adherend when the structured surface side of the adhesive layer is applied to the adherend.

In some embodiments, the water sealing adhesive film for decoration of the present disclosure may further include, as optional constituents, additional layers such as a protective layer, a decorative layer, a brightening layer, and a bonding layer for bonding constituent layers to each other (may be referred to as a “primer layer”, “third adhesive layer” or the like). These additional layers can be employed alone or in combination of two or more.

In some embodiments, a protective layer can be disposed on the outermost surface opposite to the adhesive layer of the adhesive film. The protective layer may have a function to protect other layers constituting the adhesive film, such as a decorative layer, from punctures, impacts, or the like from the outside.

The protective layer may be a multi-layer laminate, for example, a multi-layer extrusion laminate. The protective layer may have a receptor layer on its surface, and the protective layer itself may have receptor performance. By using a protective layer having a receptor layer or receptor performance, a decorative layer such as a graphic image can be directly formed on the protective layer by inkjet printing or the like. The protective layer may have a substantially smooth surface, or may have an uneven shape such as a matte pattern or an emboss pattern on the surface. The surface of the protective layer may be subjected to surface treatment such as corona treatment or plasma treatment.

As materials of the protective layer, a variety of resins, for example, (meth)acrylic resins including polymethyl methacrylate (PMMA), polyurethane, fluorine resins such as ethylene-tetrafluoroethylene copolymer (ETFE), polyvinylidene fluoride (PVDF), and methyl methacrylate-vinylidene fluoride copolymer, silicone-based copolymer, polyvinyl chloride, polycarbonate, acrylonitrile-butadiene-styrene copolymer (ABS), polyolefins such as polyethylene and polypropylene, polyesters such as polyethylene terephthalate (PET) and polyethylene naphthalate (PEN), and copolymers such as ethylene-acrylic acid copolymer, ethylene-ethyl acrylate copolymer, and ethylene-vinyl acetate copolymer, or mixtures thereof can be used. From the viewpoints of transparency, strength, impact resistance, and the like, a (meth)acrylic resin, polyurethane, a fluorine resin, polyvinyl chloride, polyethylene terephthalate, an acrylonitrile-butadiene-styrene copolymer, and polycarbonate can be advantageously used as materials for the protective layer. Furthermore, from the viewpoint of weather resistance, a (meth)acrylic resin is advantageous.

The protective layer may contain, as necessary, UV absorbents such as benzotriazole, Tinuvin (trade name) 400 (available from BASF), and hindered amine light stabilizers (HALS) such as Tinuvin (trade name) 292 (available from BASF). By using UV absorbents, hindered amine light stabilizers, and the like, deterioration of layers located under the protective layer, for example, discoloration, fading, and deterioration of the decorative layer can be effectively prevented. The protective layer may include a hard coating material, a luster-imparting agent, and the like, and may also have an additional hard coating layer.

In order to provide an intended appearance (e.g., matte appearance), the protective layer may be transparent, semitransparent, or opaque entirely or partially in a visible area. The protective layer may be colorless or may be colored entirely or partially.

The thickness of the protective layer can be approximately 1 micrometer or greater, approximately 5 micrometers or greater, approximately 10 micrometers or greater, approximately 25 micrometers or greater, or approximately 40 micrometers or greater, and can be approximately 500 micrometers or less, approximately 300 micrometers or less, approximately 100 micrometers or less, approximately 50 micrometers or less, approximately 40 micrometers or less, or approximately 30 micrometers or less.

In some embodiments, the adhesive film of the present disclosure can have a decorative layer disposed, for example, on or under the substrate. The decorative layer can be applied to the entire surface or a portion of the substrate, for example.

Examples of the decorative layer include, but are not limited to, a color layer that exhibits a paint color, for example, a light color, such as white and yellow, and a strong color, such as red, brown, green, blue, gray, and black; a pattern layer that imparts a design pattern (such as a wood grain, a stone grain, a geometric pattern, or a leather pattern), a logo, a picture pattern, or the like to an article; a relief (embossed pattern) layer in which an uneven shape is provided on the surface; and combinations of these layers. The decorative layer of the present disclosure can also include a graphic image or a layer referred to as a graphic layer.

The raw material for the color layer is not limited to the following, but for example, a raw material obtained by dispersing a pigment in a binder resin, such as a (meth)acrylic resin or a polyurethane resin, can be used, the pigment being, such as an inorganic pigment (such as carbon black, chrome yellow, yellow iron oxide, colcothar, or red iron oxide); or an organic pigment, such as a phthalocyanine pigment (such as phthalocyanine blue or phthalocyanine green), an azo lake pigment, an indigo pigment, a perinone pigment, a perylene pigment, a quinophthalone pigment, a dioxazine pigment, or a quinacridone pigment (such as quinacridone red).

The color layer can be formed using such a raw material, for example, by a coating method, such as gravure coating, roll coating, die coating, bar coating or knife coating, or can be also formed by a printing method, such as inkjet printing, screen printing, gravure printing, offset printing, laser printing or electrostatic printing.

As a pattern layer, although not limited to the following, pattern layers obtained by printing a pattern such as a pattern, logo, or design on the substrate or the like using a printing method such as gravure printing, offset printing, inkjet printing, laser printing, screen printing, or electrostatic printing may be employed, or a film, sheet, or the like having a pattern, logo, design, or the like formed by coating such as gravure coating, roll coating, die coating, bar coating, or knife coating, punching, etching, or the like also can be used. For example, a raw material similar to those used in the color layer can be used for the pattern layer.

For the relief layer, a thermoplastic resin film having an uneven shape on the surface may be used, the uneven shape being obtained by a well-known method in the art, such as, for example, emboss finishing, scratch processing, laser processing, dry etching processing, or hot press processing. The relief layer can be formed by applying a heat-curable or ionizing radiation-curable resin such as curable (meth)acrylic resin on a release liner having an uneven shape, curing the resin by heat or ionizing radiation irradiation, and removing the release liner.

The thermoplastic resin, heat-curable resin and ionizing radiation-curable resin used in the relief layer are not particularly limited; for example, fluorine resin, polyester resin such as PET and PEN, (meth)acrylic resin, polyolefin resin such as polyethylene and polypropylene, thermoplastic elastomer, polycarbonate resin, polyamide resin, ABS resin, acrylonitrile-styrene resin, polystyrene resin, vinyl chloride resin, and polyurethane resin can be used. The relief layer may include at least one type of pigment used in the color layer.

The thickness of the decorative layer may be appropriately adjusted in accordance with the required decorativeness and the like and is not particularly limited. For example, the thickness can be approximately 1 micrometer or greater, approximately 3 micrometers or greater, or approximately 5 micrometers or greater, and can be approximately 50 micrometers or less, approximately 40 micrometers or less, approximately 30 micrometers or less, approximately 20 micrometers or less, or approximately 15 micrometers or less.

Examples of the brightening layer (sometimes referred to as “metal layer”) may include, but are not limited to, layers containing a metal selected from aluminum, nickel, gold, silver, copper, platinum, chromium, iron, steel, tin, indium, titanium, lead, zinc, or germanium, or an alloy or compound thereof, formed by vacuum deposition, sputtering, ion plating, plating, or the like on the entire surface or a portion of the substrate, the protective layer or the decorative layer. The brightening layer may be applied in the form of a foil or sheet.

The thickness of the brightening layer is not particularly limited, and can be appropriately selected in accordance with the required performance (for example, decorativeness, brightness and incombustibility) and costs. For example, in the case where incombustibility is required in addition to decorativeness, the thickness of the brightening layer can be approximately 8 micrometers or greater, approximately 10 micrometers or greater, or approximately 15 micrometers or greater, and can be approximately 200 micrometers or less, approximately 150 micrometers or less, or approximately 100 micrometers or less. For example, in the case where the brightening layer contains aluminum, the thickness of the brightening layer can be approximately 12 micrometer or greater, approximately 15 micrometers or greater, or approximately 25 micrometers or greater, and can be approximately 30 micrometer or greater, approximately 40 micrometers or greater, or approximately 50 micrometers or greater, and thus more excellent incombustibility can be obtained. In the case where incombustibility is not required, the thickness of the brightening layer can be approximately less than 8 micrometers or approximately 5 micrometers or less, and can be approximately 0.1 micrometers or greater, 0.5 micrometers or greater, or 1 micrometer or greater.

In some embodiments, the adhesive film of the present disclosure can include a bonding layer to bond the constituent layers. For the bonding layer, for example, a typically used adhesive can be used, such as a solvent, emulsion, pressure-sensitive, heat-sensitive, thermosetting, or ultraviolet-curable adhesive containing a known resin such as a (meth)acrylic resin, polyolefin-based resin, polyurethane-based resin, polyester-based resin, vinyl acetate-based resin, silicone-based resin, or rubber-based resin. The bonding layer can be applied by a well-known coating method or the like.

The thickness of the bonding layer can be, for example, approximately 0.05 micrometers or greater, approximately 0.5 micrometers or greater, approximately 5 micrometers or greater, approximately 10 micrometers or greater, approximately 20 micrometers or greater, or approximately 30 micrometers or greater, and can be approximately 200 micrometers or less, approximately 100 micrometers or less, approximately 50 micrometers or less, approximately 20 micrometers or less, or approximately 10 micrometers or less.

In some embodiments, the additional layers such as the protective layer, the decorative layer, and the bonding layer can contain, in accordance with the use application and the like, as optional components, fillers, reinforcing materials, antioxidants, frame retardants, antibacterial agents, deodorants, UV absorbents, photostabilizers, thermal stabilizers, dispersants, plasticizers, flow enhancing agents, tackifiers, leveling agents, silane coupling agents, catalysts, pigments, dyes, thickeners, binder resins, and the like. These optional components can be used alone, or in combination of two or more types.

The water sealing adhesive film for decoration of the present disclosure can be prepared as appropriate by known methods, such as a printing method such as gravure direct printing, gravure offset printing, inkjet printing, or screen printing; a coating method such as gravure coating, roll coating, die coating, bar coating, knife coating, or extrusion coating; and a lamination method, a transfer method, a bonding method, a vapor deposition method, or a plating method, alone or in combination.

The following production method is described as an example, but the method of producing a water sealing adhesive film for decoration is not limited thereto. For example, in the case of a water sealing adhesive film for decoration having a structure in which a release liner, an adhesive layer, a substrate, a bonding layer, a decorative layer, and a protective layer are provided in this order, an adhesive composition containing a tacky binder, a crosslinking agent, and a water absorbing resin is applied onto a release liner having an embossed pattern corresponding to a structured surface, and optionally dried and/or crosslinked to prepare a laminate A including the adhesive layer. A bonding layer-forming composition is applied onto a substrate, and optionally dried and/or crosslinked to form a bonding layer, and then a resin film having a decorative layer on its one surface is adhered to the bonding layer via the decorative layer to prepare a laminate B. An adhesive film can be obtained by adhering the adhesive layer of the laminate A to the substrate surface of the laminate B. The crosslinking of the adhesive layer may be performed after the laminate A and the laminate B are adhered together.

Alternatively, an adhesive composition containing a tacky binder, a crosslinking agent, microspheres, and a water absorbing resin is applied to the substrate surface of the laminate B described above, optionally dried, and then crosslinked to obtain an adhesive film.

The water sealing adhesive film for decoration of the present disclosure can exhibit excellent water sealing property and adhesiveness, despite the adhesive layer having a structured surface.

The structured surface of the adhesive layer can be evaluated by, for example, a wet-out test as which will be described in the following Examples. A smaller value of wet-out ratio determined through such a test indicates a smaller contact area between the adherend and the adhesive layer, that is, a greater channel formation proportion, and a larger value of wet-out ratio indicates a larger contact area between the adherend and the adhesive layer, i.e., a lower channel formation proportion. In some embodiments, the water sealing adhesive film for decoration of the present disclosure can achieve a wet-out ratio of approximately 30% or greater, approximately 35% or greater, or approximately 40% or greater, but approximately 90% or less, approximately 88% or less, approximately 85% or less, or approximately 80% or less.

The water sealing property can be evaluated, for example, by a water sealing test as will be described in the following Examples. In some embodiments, the water sealing adhesive film for decoration of the present disclosure can be evaluated as “B” or “A” in the water sealing test.

The adhesiveness can be evaluated, for example, by an adhesive force test as will be described in the following Examples. The adhesive strength of the adhesive film varies depending on the adherend surface, but, in some embodiments, the water sealing adhesive film for decoration of the present disclosure can attain an adhesive force of approximately 0.5 N/25 mm or greater, approximately 1 N/25 mm or greater, approximately 3 N/25 mm or greater, approximately 5 N/25 mm or greater, approximately 60 N/25 mm or less, approximately 55 N/25 mm or less, approximately 50 N/25 mm or less, or approximately 45 N/25 mm or less, when expressed by 180 degree peeling force.

The shear force of the structure in which the adhesive film and the adherend are adhered to each other varies depending on the adherend surface, but, in some embodiments, the water sealing adhesive film for decoration of the present disclosure can attain a shear force of approximately 0.05 MPa or greater or approximately 0.10 MPa or greater, but approximately 1.5 MPa or less or approximately 1.0 MPa or less. The adhesive film can exhibit high shear force, especially when applied to a rough surface. Without wishing to be bound by any theory, this is because the uneven surface of the adhesive layer mates with the unevenness of the rough surface. High shear force is advantageous to prevent slipping caused by the weight of the adhesive sheet when the adhesive film is applied to a vertical surface. The shear force is defined as an adhesive force obtained by producing a test piece by cutting out an adhesive film into a rectangular shape having a width of 25 mm and a length of 60 mm, adhering the test piece onto an aluminum panel having a width of 25 mm, a length of 60 mm, and a thickness of 1 mm using a roller at 23° C. in a manner that the contact region is 25 mm×12 mm and then leaving at 20° C. for 24 hours, and performing a measurement using a tensile tester at 20° C. at a tensile speed of 50 mm/min.

According to an embodiment of the present disclosure, there is provided a structure in which the adhesive layer of the above-described water sealing adhesive film for decoration is disposed on the surface of the adherend. The adhesive film of the present disclosure can be applied not only to an adherend having a substantially flat surface, but also to an adherend having unevenness or an adherend having a curved shape or three-dimensional shape, and thus can be used in various applications.

The material for the adherend is not particularly limited, and, for example, a resin material, an inorganic material (for example, glass, ceramic, or concrete), a metal material, a wood material, or the like can be used. The adhesive film of the present disclosure has water sealing performance, and thus is useful when the adherend is applied to at least one selected from members that easily invoke water at the interface between the adhesive layer and the adherend, for example, a hydrophilic member, a hygroscopic member, and a porous member. Examples of the material for such a member include glass, ceramic, concrete, and mortar. Here, the term “hydrophilic” can mean, for example, that the contact angle with water of the outermost surface of the adherend is approximately less than 90°, approximately 700 or less, approximately 50° or less, or approximately 25° or less. The contact angle with water can be a value measured in accordance with the static drop method described in JIS R 3257 (1999). The term “hygroscopic” means the ability to absorb ambient moisture, and the presence or absence of such performance can be confirmed by, for example, the moisture absorption/desorption test described in JIS A 1470-1 (2014).

The water sealing adhesive film for decoration of the present disclosure can be applied to a variety of applications and surfaces, and, in particular, can be advantageously used in environments where the adhesive film is exposed to water. In some embodiments, the water sealing adhesive film for decoration of the present disclosure can be used in an outdoor or indoor wet area. Specifically, the water sealing adhesive film for decoration of the present disclosure can be used for structures exposed to the outdoors, such as signs, signboards or bridges, buildings such as houses or buildings, or wall surfaces, floor surfaces, ceiling surfaces, door surfaces, door surfaces, window surfaces or the like in kitchens, bathrooms, toilets or the like, which may be exposed to water indoors.

### EXAMPLES

In the following examples, specific embodiments of the present disclosure will be illustrated, but the present invention is not limited to these examples. All “parts” and “percent” are based on mass unless otherwise specified. The “Tg” in Table 1 means the glass transition temperature, and the “Mw” means the weight average molecular weight. Here, the glass transition temperature is a value obtained from the FOX equation, assuming that a polymer is copolymerized from n kinds of monomers. The weight average molecular weight is a weight average molecular weight, as converted in terms of polystyrene in a tetrahydrofuran (THF) solvent, in gel infiltration chromatograph measurement.

The raw materials used in the examples are shown in Table 1 below.

TABLE 1

| | | | Solid | |
|---|---|---|---|---|
| Material | Composition or description | Solvent | content (%) | Manufacturer |
| Water | AQUALIC CS (trade name) | — | 100 | Nippon |
| absorbing | 6S, modified polyacrylic | | | Shokubai Co, |
| resin (SAP1) | crosslinked product | | | Ltd. |
| Tacky binder 1 | 2EHA-BA-AA = 62:32:6, | Ethyl | 60 | — |
| (ADH1) | Tg: −57° C., Mw: 250000 | acetate | | |
| Tacky binder 2 | 2EHA-BA-AA = 62:32:6, | Ethyl | 60 | — |
| (ADH2) | Tg: −57° C., Mw: 290000 | acetate | | |
| Tacky binder 3 | SK-Dyne (trade name) E- | Water | 55 | Soken |
| (ADH3) | 313, acrylic adhesive | | | Chemical & |
| | | | | Engineering |
| | | | | Co., Ltd. |
| Elastic resin | 2EHA-AA-1,4BDA = | Water | 35 | — |
| microspheres | 94:6:0.025, volume average | | | |
| (LSA1) | particle diameter (Dv): 137 μm | | | |
| Resin (P1) | MMA-BMA-DMAEMA = 60:34:6, | Ethyl | 40 | — |
| | Tg: 63° C., Mw: 68000 | acetate | | |
| Crosslinking | Epoxy-based crosslinking | Toluene | 5 | Soken |
| agent (CL1) | agent E-Ax | | | Chemical & |
| | | | | Engineering |
| | | | | Co., Ltd. |
| Pigment | TiPureR960, titanium oxide | — | — | Chemours |
| (PIG1) | pigment | | | Company |
| Polyester film | Cosmoshine (trade name) | — | — | Toyobo Co., |
| (PET1) | A4300, 188 μm-thick rigid | | | Ltd. |
| | polyester film | | | |
| Release liner | SCW1034 Comply (trade | — | — | 3M Japan |
| (L1) | name) liner, silicone-coated | | | Limited |
| | polyethylene laminated | | | |
| | release paper with structured | | | |
| | surface | | | |

MMA: Methyl methacrylate
BMA: Butyl methacrylate
DMAEMA: Dimethylaminoethyl methacrylate
BA: Butyl acrylate
AA: Acrylic acid
2EHA: 2-ethylhexyl acrylate
1,4-BDA: 1,4-butanediol diacrylate

### Preparation of Tacky Binder 1 (ADH1)

An ethyl acetate solution (solid content: 60%) of a tacky binder 1 (ADH1) was prepared by dissolving 62 parts by mass of 2-ethylhexyl acrylate (2EHA), 32 parts by mass of butyl acrylate (BA) and 6 parts by mass of acrylic acid (AA) in 66.7 parts by mass of ethyl acetate, adding 0.7 parts by mass of dimethyl 2,2′-azobis(2-methylpropionate) (trade name: V-601, available from FUJIFILM Wako Pure Chemical Corporation (Osaka-shi, Osaka, Japan)) as a polymerization initiator, and then reacting the mixture for 24 hours at 75° C. in a nitrogen atmosphere. The weight average molecular weight (Mw) of ADH1 was 250000, and the glass transition temperature (Tg) was −57° C.

### Preparation of Tacky Binder 2 (ADH2)

An ethyl acetate solution (solid content: 60%) of a tacky binder 2 (ADH2) was prepared by dissolving 62 parts by mass of 2-ethylhexyl acrylate (2EHA), 32 parts by mass of butyl acrylate (BA) and 6 parts by mass of acrylic acid (AA) in 66.7 parts by mass of ethyl acetate, adding 0.55 parts by mass of dimethyl 2,2′-azobis(2-methylpropionate) (trade name: V-601, available from FUJIFILM Wako Pure Chemical Corporation (Osaka-shi, Osaka, Japan) as a polymerization initiator, and then reacting the mixture for 24 hours at 75° C. in a nitrogen atmosphere. The weight average molecular weight (Mw) of ADH2 was 290000, and the glass transition temperature (Tg) was −57° C.

### Preparation of Elastic Resin Microspheres (LSA 1)

The elastic resin microspheres 1 (LSA 1) were prepared by the following procedure. In a 1 L glass flask equipped with a baffle plate, 1.5 g of polyvinyl alcohol (degree of saponification: approximately 88 mol %; viscosity: approximately 95 mPa·s; pH: approximately 6) and 279 g of deionized water were charged. The temperature of the mixture was increased to 45° C. using an IR stirrer and the mixture was mixed by the stirrer. After the particles of the polyvinyl alcohol are completely dissolved in water, a premix that was placed in a jar and that contained 141 g of 2-ethylhexyl acrylate, 9 g of acrylic acid, and 0.0375 g of 1,4-butanediol diacrylate was poured into the flask. The mixture was stirred by an impeller blade having a size of 45 mm at a stirring rate of 457 rpm, and the flask was heated again to 45° C. while a nitrogen gas was bubbled into the mixture. At the time when the temperature reached 45° C., 0.45 g of 2,2′-azobis(2,4-dimethylvaleronitrile) (AVN) was added to the mixture. The polymerization had been initiated in approximately 1 hour after the AVN was added, and the temperature had been increased along with the exothermic reaction. After the temperature increase was stopped, the temperature setting was raised to 65° C. and this temperature was maintained for 3 hours after the initiation of the polymerization. Thereafter, the mixture was cooled, and the obtained polymer suspension was filtered through a #16 metal mesh. The volume average particle diameter of the obtained microspheres was measured by using a laser diffraction particle diameter analyzer, Beckman Coulter LS230. The volume average particle diameter of the LSA 1 was approximately 137 micrometers. The viscoelasticity measurement of the LSA 1 was performed using the RSA II viscoelasticity spectrometer, manufactured by Rheometrics (Advanced Rheometric Expansion System (ARES)). The shear storage modulus at 25° C. was 7×10⁵ dyn/cm², and the compressive elastic modulus was approximately 2.3×10⁴ Pa.

### (Resin (P1))

An ethyl acetate solution (solid content: 40%) of a high-Tg resin (P1) was prepared by dissolving 60 parts by mass of methyl methacrylate (MMA), 34 parts by mass of butyl acrylate (BMA) and 6 parts by mass of dimethylaminoethyl methacrylate (DMAEMA) in 150 parts by mass of ethyl acetate, adding 0.6 parts by mass of dimethyl-2,2-azobis(2-methylpropionate) (trade name: V-601, available from FUJIFILM Wako Pure Chemical Corporation (Osaka-shi, Osaka, Japan) as a polymerization initiator, and then reacting the mixture for 24 hours at 65° C. in a nitrogen atmosphere. The weight average molecular weight (Mw) of P1 was 68000, and the glass transition temperature (Tg) was 63° C.

### Example 1

A white bonding layer-forming solution was prepared by mixing ADH2, P1, PIG1 and CL1. The mass ratio of ADH2, PIG1, P1 and CL1 was 100:50:10:0.2 based on the nonvolatile content (solid content). The nonvolatile content (solid content) of the white bonding layer-forming solution was approximately 55%. The PET 1 was coated with the white bonding layer-forming solution using a knife coater. The coated layer was dried and crosslinked at approximately 95° C. for approximately 5 minutes to obtain a white bonding layer having a thickness of approximately 30 micrometers. To temporarily protect the white bonding layer, a substantially flat release liner was laminated on the bonding layer.

An adhesive solution was prepared by mixing ADH1, LSA1 and SAP1. The mass ratio of ADH1, LSA1 and SAP1 was 100:25:2 based on the nonvolatile content (solid content). The nonvolatile content (solid content) of the adhesive solution was approximately 46%. CL1 was mixed with the adhesive solution. The mass ratio of ADH1 to CL1 was 100:0.20 based on the nonvolatile content (solid content). Another surface of PET 1 on a side opposite to the white bonding layer was coated with the adhesive solution using a knife coater. The coated layer was dried and crosslinked at approximately 95° C. for approximately 5 minutes to obtain an adhesive layer with a structured surface, having a thickness of approximately 104 micrometers. The dry coating weight of the adhesive layer containing the water absorbing resin (SAP1) was approximately 70 g/m². A substantially flat release liner was laminated on the adhesive layer to temporarily protect the adhesive layer. After removal of the release liner on the white bonding layer, a Scotchcal (trade name) Paint Film PF997 (BSPC: transparent film having a printable back surface; available from 3M Japan Ltd.) with a graphic image was laminated to obtain an adhesive film of Example 1.

### Example 2

An adhesive film of Example 2 was prepared in the same manner as in Example 1 with the exception that the dry coating weight of the adhesive layer was changed to approximately 75 g/m².

### Example 3

PET 1 having a white bonding layer was prepared in the same manner as in Example 1. A first adhesive solution was prepared by mixing ADH3 and LSA1. The mass ratio of ADH3 to LSA1 was 100:50 based on the nonvolatile content (solid content). CL1 was mixed with the first adhesive solution. The mass ratio of ADH3 to CL1 was 100:0.09 based on the nonvolatile content (solid content). The nonvolatile content (solid content) of the first adhesive solution was approximately 46%. Another surface of PET 1 on a side opposite to the white bonding layer was coated with the first adhesive solution using a knife coater. The coated layer was dried and crosslinked at approximately 95° C. for approximately 5 minutes to obtain a first adhesive layer with a structured surface, having a thickness of approximately 70 micrometers. The dry coating weight of the first adhesive layer was approximately 53 g/m².

A second adhesive solution was prepared by mixing ADH2, P1, SAP1 and CL1. The mass ratio of ADH2, P1, SAP1 and CL1 was 100:5:10:0.18 based on the nonvolatile content (solid content). The nonvolatile content (solid content) of the second adhesive solution was approximately 52%. The first adhesive layer was coated with the second adhesive solution using a knife coater. The coated layer was dried and crosslinked at approximately 95° C. for approximately 5 minutes to prepare a second adhesive layer containing a water absorbing resin (SAP1) having a thickness of approximately 21 micrometers on the first adhesive layer having a structured surface. The dry coating weight of the second adhesive layer was approximately 41 g/m². A substantially flat release liner was laminated on the adhesive layer to temporarily protect the adhesive layer. After removal of the release liner on the white bonding layer, a Scotchcal (trade name) paint film PF997 (BSPC: transparent film having a printable back surface; available from 3M Japan Ltd.) with a graphic image was laminated to obtain an adhesive film of Example 3.

### Example 4

An adhesive film of Example 4 was prepared in the same manner as in Example 3 with the exception that the dry coating weight of the second adhesive layer was changed to approximately 42 g/m².

### Example 5

An adhesive film of Example 5 was prepared in the same manner as in Example 3 with the exception that the dry coating weight of the second adhesive layer was changed to approximately 55 g/m².

### Example 6

An adhesive solution was prepared by mixing ADH2, P1, SAP1 and CL1. The mass ratio of ADH2, P1, SAP1 and CL1 was 100:5:10:0.15 based on the nonvolatile content (solid content). The nonvolatile content (solid content) of the adhesive solution was approximately 52%. The adhesive solution was applied onto a release liner L1 having an embossed pattern corresponding to the structured surface using a knife coater. The coated layer was dried and crosslinked at approximately 95° C. for approximately 5 minutes to prepare an adhesive layer with a structured surface, containing a water absorbing resin (SAP1) and having a thickness of approximately 41 micrometers. The dry coating weight of the adhesive layer was 38 g/m². A polyvinyl chloride film having a thickness of approximately 50 micrometers was laminated on the adhesive layer containing the water absorbing resin (SAP1) to obtain an adhesive film of Example 6.

### Example 7

An adhesive film of Example 7 was prepared in the same manner as in Example 6 with the exception that the mass ratio of the water absorbing resin (SAP1) was 5 parts by mass and the thickness of the adhesive layer was changed to approximately 39 micrometers.

### Example 8

An adhesive film of Example 8 was prepared in the same manner as in Example 6 with the exception that a polyvinyl chloride film having a thickness of approximately 170 micrometers was used instead.

### Example 9

An adhesive film of Example 9 was prepared in the same manner as in Example 7 with the exception that a polyvinyl chloride film having a thickness of approximately 170 micrometers was used instead.

### Comparative Example 1

An adhesive film of Comparative Example 1 was prepared in the same manner as in Example 3 with the exception that the second adhesive layer containing the water absorbing resin (SAP1) was not provided on the first adhesive layer having the structured surface.

### Comparative Example 2

An adhesive film of Comparative Example 2 was prepared in the same manner as in Example 6 with the exception that an adhesive solution without the water absorbing resin (SAP1) was used instead.

### Comparative Example 3

An adhesive film of Comparative Example 3 was prepared in the same manner as in Example 8 with the exception that an adhesive solution without the water absorbing resin (SAP1) was used instead.

### Physical Property Evaluation Tests

The properties of the adhesive films were evaluated using the following methods.

### (Water Sealing Test)

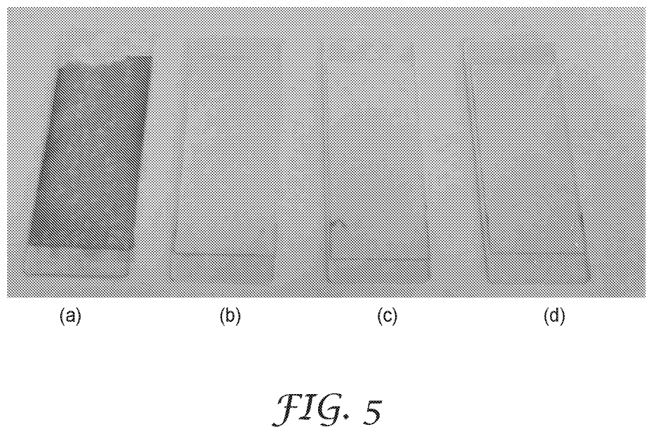

A test piece was prepared by cutting an adhesive film into a size of a width of 25 mm and a length of 60 mm. The test piece was adhered to a glass plate (available from Matsunami Glass Ind., Ltd.) at 23° C. A sample was prepared by immersing an end of the test piece by approximately 5 mm in dyed water. The resulting sample was placed in a thermostatic bath at 23° C. After 24 hours, the appearance of the adhesive surface was visually observed to evaluate the water sealing property according to the following criteria. Here, “A” and “B” correspond to acceptance, and “C” and “D” correspond to failure. Photographs of samples of Comparative Example 1 and Examples 3 to 5 after the test are shown in FIG. 5. FIG. 5(a) corresponds to Comparative Example 1; FIG. 5(b) corresponds to Example 3: FIG. 5(c) corresponds to Example 4; and FIG. 5(d) corresponds to Example 5.
A: The area of the sample which the dyed water permeated was 5% or less.
B: The area of the sample which the dyed water permeated was greater than 5% and 20% or less.
C: The area of the sample which the dyed water permeated was greater than 20%.
D: The sample was peeled from the glass plate.

### (Adhesive Force Test)

A test piece was prepared by cutting an adhesive film into a size of a width of 25 mm and a length of 150 mm. The test piece was adhered onto a melamine-coated panel (available from Paltek Corporation), a mortar substrate, and a ceramic tile, respectively, at 23° C. The adhering method was in accordance with JIS Z 0237 8.2.3. The test piece was left at 20° C. for 24 hours. The adhesive force at the time of performing 180 degree peeling was measured at a peeling rate of 300 mm/min at 20° C. using a tensile tester (Tensilon universal testing machine, model: RTC-1210A, available from A&D Company, Limited).

### (Wet-Out Test)

A slide glass having a vertical length of 76 mm, a lateral length of 26 mm, and a thickness of 1 mm (available from Matsunami Glass Ind., Ltd., MICRO SLIDE GLASS White Edge Polished, No. 1; Ra of the flat surface: approximately 0.001 micrometers) was prepared. The adhesive layer surface of the adhesive film prepared into a size of a width of 25 mm and a length of 60 mm was adhered to the glass slide, and pressure-bonded thereto through three reciprocations of a 2-kg roller in the length direction, thereby preparing a test piece. When white light was applied to the glass surface on the side where the adhesive film was not adhered, and the test piece was observed via a polarizing filter, a region (contact region) where the protruding adhesive part and the glass surface were in contact looked brackish, and a non-contact region looked whitish. The procedure was performed using an optical microscope (EMP-ST, manufactured by Kyowa Optical Co., Ltd.), and image data was captured via a CCD camera (TI-32XA, NEC Corporation) into an image processor (Excell-II, available from Nippon Avionics Co., Ltd.). The ratio of the total area of the contact area to the area of the entire observation visual field (corresponding to the apparent contact area) was expressed in “%”, and this ratio was referred to as the “wet-out ratio”. The area of the observation visual field was approximately 1 cm².

The details of the adhesive layers of the adhesive films produced are indicated in Table 2, and the evaluation results are indicated in Table 3. Here, the tacky binders in Example 3 to 5 in Table 2 are intended as the tacky binder used in the second adhesive layer. The items that are not evaluated in Table 3 are indicated as “ND”.

TABLE 2

| | | | Thickness | Dry coating | | |
|---|---|---|---|---|---|---|
| | | | (μm) of | weight (g/m²) | | |
| | | | adhesive | of adhesive | | |
| | | Proportion | layer | layer | Total | Total dry |
| | Tacky | (parts by mass) | containing | containing | thickness | coating |
| | binder in | of water | water | water | (μm) of | weight (g/m²) |
| | adhesive | absorbing | absorbing | absorbing | adhesive | of adhesive |
| | layer | resin | resin | resin | layer | layer |
| Example 1 | ADH1 | 2 | 104 | 70 | 104 | 70 |
| Example 2 | ADH1 | 2 | 117 | 75 | 117 | 75 |
| Example 3 | ADH2 | 10 | 21 | 41 | 91 | 94 |
| Example 4 | ADH2 | 10 | 22 | 42 | 92 | 95 |
| Example 5 | ADH2 | 10 | 26 | 55 | 96 | 108 |
| Example 6 | ADH2 | 10 | 41 | 38 | 41 | 38 |
| Example 7 | ADH2 | 5 | 39 | 35 | 39 | 35 |
| Example 8 | ADH2 | 10 | 41 | 38 | 41 | 38 |
| Example 9 | ADH2 | 5 | 39 | 35 | 39 | 35 |
| Comparative | ADH3 | 0 | 0 | 0 | 70 | 53 |
| Example 1 | | | | | | |
| Comparative | ADH2 | 0 | 0 | 0 | 41 | 38 |
| Example 2 | | | | | | |
| Comparative | ADH2 | 0 | 0 | 0 | 41 | 38 |
| Example 3 | | | | | | |

TABLE 3

| | Water | Adhesive force (N/25 mm) | | | Wet-out |
|---|---|---|---|---|---|
| | sealing | Melamine- | Mortar | Ceramic | ratio |
| | property | coated panel | substrate | tile | (%) |
| Example 1 | A | 15 | 42 | ND | 68 |
| Example 2 | A | 24 | 52 | ND | 86 |
| Example 3 | A | 5 | 11 | 4 | 40 |
| Example 4 | A | 4 | 11 | 6 | 49 |
| Example 5 | A | 6 | 18 | 8 | 63 |
| Example 6 | B | 14 | 23 | 17 | 71 |
| Example 7 | A | 16 | 25 | 21 | 71 |
| Example 8 | B | 10 | 18 | 14 | 61 |
| Example 9 | B | 12 | 20 | 18 | 65 |
| Comparative | D | 2 | 5 | 2 | 32 |
| Example 1 | | | | | |
| Comparative | C | 20 | 26 | 22 | 79 |
| Example 2 | | | | | |
| Comparative | C | 15 | 21 | 15 | 69 |
| Example 3 | | | | | |

Various variations of the above embodiments and examples will be apparent to those skilled in the art without departing from the basic principle of the present invention. In addition, various modifications and variations of the present invention will be apparent to those skilled in the art without departing from the spirit and scope of the present invention.

### REFERENCE SIGNS LIST

100, 200, 300, 400 Water sealing adhesive film for decoration
101, 201, 301, 401 Substrate
105, 205, 305, 405 Adhesive layer
202 First adhesive layer
203 Second adhesive layer
107, 207 Microsphere
309 Release liner having embossed pattern corresponding to structured surface
410 Adherend

1. A water sealing adhesive film for decoration comprising:
a substrate; and
an adhesive layer having a structured surface and being disposed on the substrate, the adhesive layer comprising a tacky binder having a crosslinked structure derived from a crosslinking agent, and a water absorbing resin.

2. The adhesive film according to claim 1, wherein the tacky binder comprises a (meth)acrylic resin.

3. The adhesive film according to claim 1, wherein a content of the water absorbing resin is 1 part by mass or greater and 30 parts by mass or less, based on 100 parts by mass of the tacky binder.

4. The adhesive film according to claim 1, wherein a release liner having an uneven surface corresponding to the structured surface is disposed on the adhesive layer via the uneven surface.

5. The adhesive film according to claim 1, wherein the adhesive layer comprises microspheres having a volume average particle diameter of 110 micrometers or greater.

6. The adhesive film according to claim 1,
wherein the adhesive layer comprises a first adhesive layer located on the substrate side and a second adhesive layer located on the outermost surface,
the first adhesive layer comprises a tacky binder having a crosslinked structure derived from a crosslinking agent, and microspheres having a volume average particle diameter of 110 micrometers or greater, and
the second adhesive layer comprises a tacky binder having a crosslinked structure derived from a crosslinking agent, and a water absorbing resin.

7. The adhesive film according to claim 5, wherein the microspheres comprise a (meth)acrylic resin.

8. The adhesive according to claim 1, which is intended for use outdoors.

9. The adhesive film according to claim 1, which is intended for use in an indoor wet area.

10. A structure wherein the adhesive film described in claim 1 is disposed on an adherend via the adhesive layer.

11. The according to claim 10, wherein the adherend is at least one selected from a hydrophilic member, a hygroscopic member, and a porous member.
